(19) United States
(12) Patent Application Publication
(10) Pub. No.: US 2005/0108028 A1
(43) Pub. Date: May 19, 2005

(54) Methods and apparatus for marketing mortgage insurance and associated products and performing transactions including mortgage insurance

(75) Inventor: Kurt L. Arehart, Raleigh, NC (US)

Correspondence Address: PRIEST & GOLDSTEIN PLLC, 5015 SOUTHPARK DRIVE, SUITE 230, DURHAM, NC, 27713-7736, US

(73) Assignee: GE Mortgage Holdings, LLC, Raleigh, NC (US)

(21) Appl. No.: 10/714,278

(22) Filed: Nov. 14, 2003

(51) Int. Cl. G06F 17/60

(52) U.S. Cl. 705/1

(57) ABSTRACT

Systems and techniques for marketing and implementing transactions involving mortgage financing are described. A system according to one aspect of the invention includes a data repository storing information used to design financial products and a product database including information relating to various products. At least one of the products for which information is stored in the database includes adjusting the amount of the loan to include an excess amount, adjusting the interest rate of the loan to a rate above the prevailing rate and optionally including a prepaid mortgage insurance policy with the loan, and allowing the borrower the option of purchasing discount points to reduce the interest rate to the prevailing rate. The technique further includes disbursing the excess amount of the loan to the borrower. The system may also include a comparison module receiving transaction information, computing the financial effects of available products and presenting the results to the borrower.

### FIELD OF THE INVENTION

The present invention relates generally to advantageous systems and techniques for marketing of financial service products. More particularly, the invention relates to systems and techniques for transacting mortgage financing so as to reduce the cost and enhance the value of mortgage insurance to consumers and for marketing mortgage financing transactions that may employ mortgage insurance.

### BACKGROUND OF THE INVENTION

Purchase or financing of a home by a consumer is a substantial transaction. A mortgage loan is typically quite large and is expected to be repaid over many years. A continuing risk of borrower default is present during the repayment period. In addition, default and foreclosure is a costly event for the mortgageholder, typically involving some months of missed interest payments, fees, possible depreciation of the property securing the mortgage, and sale expenses. Lenders typically require some protection against the costs of default. This protection may come in the form of a significant initial cash contribution by the borrower, typically at least 20% of the value of the property. In that case, the lender does not finance more than 80% of the value of the property, and experience has shown that this “equity cushion” is usually sufficient to cover expenses associated with default and foreclosure.

However, many borrowers wish to finance a larger proportion of the value of the property. Traditionally, lenders who finance more than 80% of the value of a property have required a borrower to pay for private mortgage insurance in order to protect the lender. Such insurance is typically necessary in order to sell a mortgage loan to investors if the loan exceeds 80% of the value of the property. Private mortgage insurance covers the shortfall in the value of the property below the amount owed in the event of default and foreclosure.

Consumers do not attach a high value to private mortgage insurance. Mortgage insurance protects the mortgage holder, not the consumer, and consumers do not see how they benefit by paying for insurance to protect another party. Moreover, monthly payments for mortgage insurance are typically not tax deductible. Accordingly, consumers are extremely receptive to arrangements that allow them to avoid paying for mortgage insurance. One such arrangement, which has proven highly popular, is a financing arrangement wherein the borrower receives a first mortgage loan for 80% of the value of the property and a second mortgage loan for 10% of the value of the property. The borrower contributes the remaining 10% of the purchase price in cash. The holder of the first mortgage is only financing 80% of the purchase price, and therefore does not need to be protected by mortgage insurance, but the borrower only needs to raise cash for 10% of the purchase price, not 20%. The interest on the second mortgage is frequently tax deductible, so that the tax advantages to the borrower offset a portion of the additional interest paid by the borrower. Traditional mortgage insurance does not offer any tax advantages, and the entire burden of the cost of the insurance is assumed by the borrower.

One disadvantage of financing using simultaneous first and second mortgage arrangements is that such arrangements are typically available only to borrowers with exceptionally good credit ratings, often manifested by a FAIR ISAAC AND COMPANY® (FICO®) score of 720-850. A borrower with such a credit rating is likely to consider alternatives to mortgage insurance, while a borrower with a lower credit rating may accept mortgage insurance with reluctance. A financial services company that could transact mortgage financing in such a way as to appeal to a consumer's specific needs would gain a considerable competitive advantage. Consumer needs that might be considered include a desire to gain tax advantages from mortgage insurance, a desire to reduce the cost of the insurance and a desire for added value features. Adjustments of financing transactions to achieve these goals would prove highly attractive to consumers.

There exists, therefore, a need for systems and techniques for designing and implementing mortgage financing in such a way as to provide enhanced value and attractive pricing of mortgage insurance. There exists an additional need for marketing the products in such a way that the consumer is able to compare different products and pricing strategies and choose the products that provide the greatest perceived value.

### SUMMARY OF THE INVENTION

In order to meet such needs, as well as others, one aspect of the present invention comprises a process of implementing a mortgage financing transaction. The process includes an initial step of preparing a loan in an amount including a base amount and an excess amount. The base amount is the amount necessary for financing and the excess amount is sufficient to purchase a prepaid mortgage insurance policy. In addition, the loan interest rate is initially set to an amount above the prevailing rate. The process further comprises a step of offering the borrower an opportunity to adjust the loan interest rate to the prevailing rate by paying for discount points to adjust the rate. If the borrower chooses to adjust the loan interest rate to the prevailing rate, a sum is received from the borrower sufficient to purchase discount points required for the adjustment. The loan interest rate is then set to the prevailing rate. If the borrower chooses not to adjust the loan interest rate to the prevailing rate, the loan interest rate is maintained at the amount above the prevailing rate. The process further includes a step of disbursing the base amount and the excess amount of the loan on behalf of the borrower. The base amount of the loan is disbursed to achieve the financing needs of the borrower. The excess amount is disbursed directly to the borrower. The process may further include an optional step in which the lender purchases a prepaid mortgage insurance policy to insure the loan.

An alternative aspect of the present invention comprises a system for marketing and implementing financial products. The system includes a data repository storing information used to design products and a product database including information relating to a variety of financial products. At least one of the products for which information is stored in the database includes a technique for mortgage financing including adjusting the amount of the loan to include an amount in excess of the borrower's financing needs, and adjusting the interest rate of the loan so as to increase the market value of the loan. The borrower will have the option of purchasing discount points to reduce the interest rate to the prevailing market rate. This product optionally includes a lender prepaid mortgage insurance policy. The technique further includes disbursing the excess amount of the loan to the borrower in cash at the closing of the loan. The system may further comprise a comparison module operative to allow a borrower to provide information relating to a contemplated transaction, the comparison module being further operative to compute the financial effects of various available products and to present the financial effects of the various products to the customer for review.

An alternative aspect of the present invention comprises a process of marketing and implementing mortgage financing transactions including mortgage insurance. The process includes providing educational and general promotional information relating to various financing options. At least one of the financing options includes implementing a mortgage financing transaction in such a way that an adjustment to the amount of the loan provides for a loan including an amount in excess of a borrower's financing needs and an adjustment to the interest rate of the loan provides for an increased value of the loan. This product optionally includes a lender prepaid mortgage insurance policy. The borrower will have the option of purchasing discount points to reduce the interest rate to the prevailing market rate, and a disbursement of the excess amount of the loan is made to the borrower in cash at the closing of the loan. The process further comprises receiving information relating to a contemplated transaction and to the financial condition of a borrower and computing and presenting information relating to the effects of various available products.

A more complete understanding of the invention, as well as further features and advantages of the invention, will be apparent from the following Detailed Description and from the claims which follow below.

### BRIEF DESCRIPTION OF THE DRAWINGS

FIG. 1 illustrates a method of conducting a mortgage loan and mortgage insurance transaction according to an aspect of the present invention;

FIG. 2 illustrates a method of conducting a mortgage loan and mortgage insurance transaction according to an aspect of the present invention;

FIG. 3 illustrates a method of conducting a mortgage loan and mortgage insurance transaction according to an aspect of the present invention;

FIG. 4 illustrates a system for designing and marketing financial products and conducting transactions involving the financial products according to an aspect of the present invention;

FIGS. 5-9 illustrate forms and displays which may suitably be employed by the system of FIG. 4 in marketing financial products and carrying out transactions involving the financial products according to an aspect of the present invention; and

FIG. 10 illustrates a process of marketing financial products and initiating transactions involving the financial products according to an aspect of the present invention.

### DETAILED DESCRIPTION

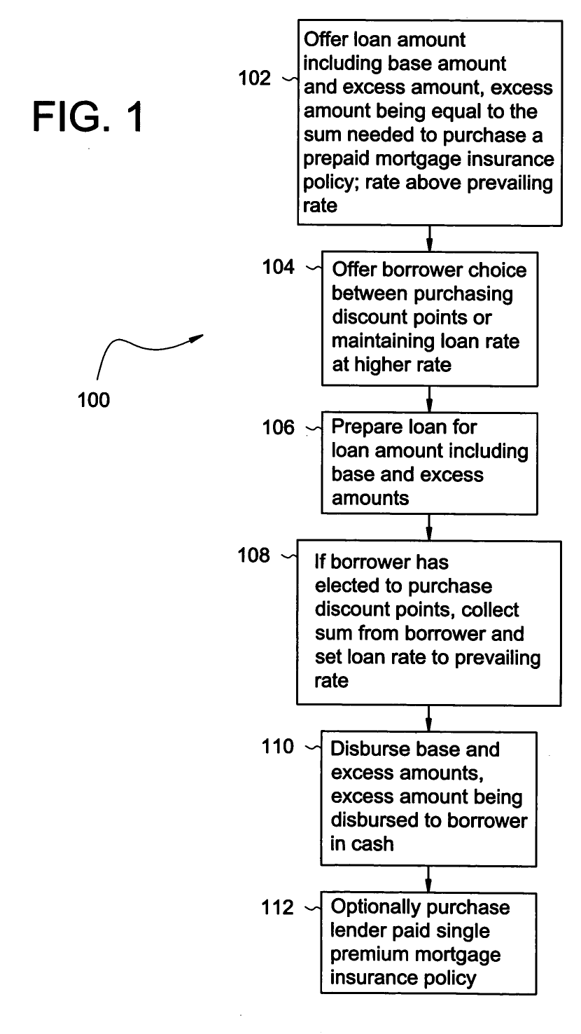

FIG. 1 illustrates a method 100 of structuring a mortgage loan and mortgage insurance transaction so as to provide a borrower with additional benefits. At step 102, upon application by a borrower for a loan for a financing need, the borrower is offered a loan amount including a base amount necessary for the financing need and an excess amount. The excess amount is preferably equal to an amount sufficient to allow the lender to purchase a prepaid mortgage insurance policy insuring the mortgage. The policy may suitably be a lender paid, nonrefundable policy. A nonrefundable policy can be offered at a significantly lower rate than can a refundable policy. With a nonrefundable prepaid policy, the purchaser takes a risk that the loan will be refinanced, prepaid or otherwise terminated earlier than expected, and the purchaser of the policy will have paid for coverage that was not needed. The purchaser of the policy can be given a lower premium rate in exchange for accepting that risk.

The mortgage insurance policy may suitably include a job loss protection feature, with the combination of mortgage insurance and job loss insurance being priced and marketed according to the teachings of U.S. patent application Ser. No. ______ assigned to a common assignee with the present invention, filed on even date herewith and incorporated by reference herein in its entirety. The job loss protection feature provides that the borrower's mortgage payment will be paid during periods of involuntary unemployment, up to a predetermined maximum number of payments. In addition, the interest rate on the loan is set at an amount above the prevailing rate.

At step 104, the borrower is offered a choice between purchasing discount points in order to reduce the interest rate on the loan to the prevailing rate, or accepting the loan at the rate above the prevailing rate and receiving a net cash disbursement at the closing of the loan. At step 106, a loan is prepared for a loan amount including the base and excess amounts. At step 108, if the borrower has elected to purchase discount points, an amount sufficient for the purchase of the discount points is collected from the borrower. This amount may suitably be equal to the excess amount of the loan. Preferably, the loan interest rate will be set so that the excess loan amount is sufficient to purchase discount points that will reduce the loan interest rate to the prevailing rate. At step 110, disbursements are made on the borrower's behalf. The base amount of the loan is disbursed as needed for the customer's financing requirements and the excess amount of the loan is disbursed to the borrower. If the borrower has paid for discount points, the loan interest rate is set to the prevailing rate. If the borrower has not paid for discount points, the loan interest rate is set to the higher rate. At step 112, the lender may optionally purchase a prepaid mortgage insurance policy to insure the loan. It will be recognized, however, that the practice of the invention does not require that the lender purchase a mortgage insurance policy. The steps of the process 100 provide for an enhanced value for the loan, justifying an expenditure by the lender to purchase a policy. However, the lender may choose to retain the loan in its portfolio, accepting the risks of default in exchange for the opportunity to enjoy the enhanced value of the loan without making an expenditure for insurance. Alternatively, the lender may sell the loan in a market that does not require mortgage insurance protection. In any case, the lender has received an enhanced value asset. In exchange for the enhanced value of the asset, the lender has been able to provide the borrower with a loan having a greater than 80% loan to value ratio. As will be discussed in greater detail below, the lender may in many cases be able to provide this loan to the borrower at a lower monthly payment than would be required for a loan with traditional mortgage insurance and with a total expenditure on the part of the borrower comparable to that required for traditional mortgage insurance.

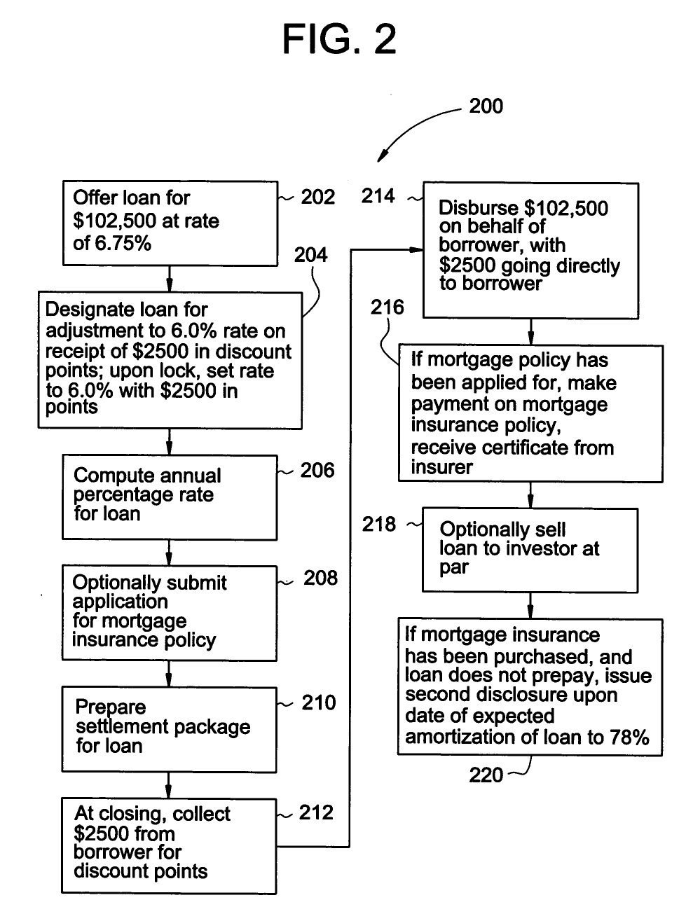

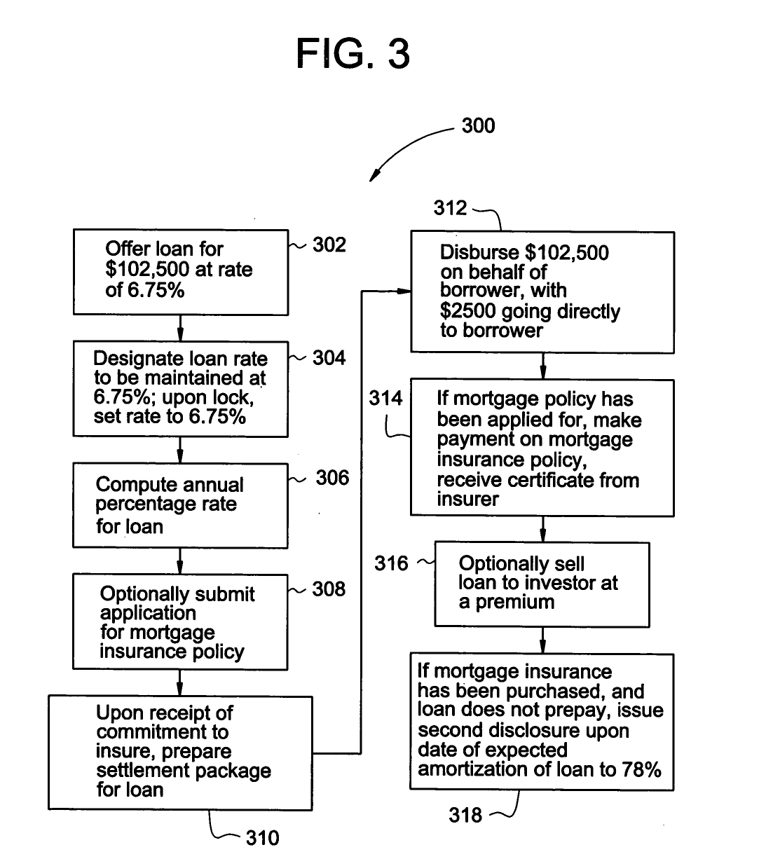

The result of structuring the transaction in this way is that the borrower may frequently obtain a desired loan, together with mortgage insurance coverage and either cash or tax advantages, with the monthly payment and total payment for the loan being equal to or less than that for a loan with conventional mortgage insurance, and with the total to be paid by the borrower over the lifetime of the loan being comparable to that for a loan with conventional mortgage insurance. The desirability of various structuring options may vary depending on the financial situation and desires of a particular consumer, and marketing of financial products may be considerably aided by the ability to effectively present the financial consequences of various options in response to information provided by consumers describing their financial status and needs. Additional details of the effects of the adjustments to the loan amount and the loan interest rate are discussed below in connection with FIGS. 2 and 3.

FIG. 2 illustrates the steps of a process 200 of structuring a mortgage loan and mortgage insurance transaction according to an aspect of the present invention. The process 200 is similar to the process 100, but in order to achieve concreteness and clarity of understanding, the transaction implemented through the process 200 is directed to a specific mortgage loan transaction for a home purchase wherein the sum required from the lender in order to finance the purchase is $100,000, the prevailing interest rate is 6.0% and a single payment mortgage insurance policy covering the mortgage is available for $2500. It will be recognized that these specific numbers are exemplary only and are not necessary to the process 200, but that any appropriate numbers may be used, depending on the specific needs and prevailing conditions influencing the transaction.

The mortgage insurance policy may suitably be a package including a job loss feature, with the package being priced and marketed according to the teachings of U.S. patent application Ser. No. ______ noted above. At step 202, upon a customer's application for a mortgage in the amount of $100,000 at an interest rate of 6.0% for a home purchase, with the purchase price being $111,111, the customer is offered a loan of $102,500 at an interest rate of 6.75%, the 6.75% being 75 basis points above the prevailing rate. Because the loan amount is $2500 more than is needed for the purchase, and because the interest rate of the loan is higher than the prevailing rate, the value of the loan to the lender, or to an investor interested in purchasing the loan from the lender, is significantly greater than the $100,000 needed to finance the purchase. Taking the prepayment risk into account, the value of a 30 year loan for $102,500, at 6.75%, with the prevailing interest rate being 6.0%, is $105,000. Because the lender is receiving an asset having a greater value, the lender is able to make concessions to the borrower so as to make the overall loan package more attractive. One consequence of the increased value of the loan is that the lender is able to provide a prepaid mortgage insurance policy without requiring any payment for the policy from the borrower.

One option that can make such a financing structure very attractive to the borrower is to allow the borrower to purchase discount points to reduce the interest rate to the prevailing rate. Because the amount of the loan is $102,500, that amount of loan proceeds will be disbursed at closing. Thus, at step 204, upon a borrower choice to purchase discount points to reduce the interest rate, the loan rate is designated for adjustment to 6.0% upon receipt of $2500 in discount points. When the borrower locks the interest rate, the rate is set to the rate of 6.0%, with the expectation that $2500 in discount points will be received from the borrower. In the present example, the amount required for the purchase of the discount points is the same as the excess amount of the loan, but the practice of the present invention does not require that these amounts be equal.

At step 206, the annual percentage rate (APR) for the loan is computed for disclosure documents, with the APR being the APR for a 6.0% note rate with a $2500 purchase of discount points required. At step 208, the lender may optionally submit an application for a lender paid single premium mortgage policy to a selected mortgage insurer. It will be recognized, however, that the purchase of third party mortgage insurance is not necessary to the practice of the present invention, because the lender is free to retain the loan in its portfolio or to sell the loan through a process that does not require the protection furnished by third party mortgage insurance. At step 210, the lender prepares a settlement package for the loan. If the lender has applied for mortgage insurance, this step occurs after the lender has received a commitment to insure. The settlement package includes a check or other means of payment for $100,000, to be disbursed according to the borrower's financing needs and a check or other means of payment for $2500, to be disbursed directly to the borrower. If the lender has applied for mortgage insurance, the package includes a lender paid mortgage insurance disclosure statement, as well as a standard settlement statement, showing the sums received from or on behalf of the borrower and the disbursements of those sums. The settlement statement shows a purchase of $2500 in discount points by the borrower. At step 212, at the closing of the loan, the sum of $2500 is collected from the borrower for the purchase of the discount points. At step 214, the sum of $102,500 is disbursed on the borrower's behalf. $100,000 is disbursed in accordance with the borrower's financing needs and $2,500 is disbursed to the borrower. In addition, the lender paid mortgage insurance disclosure and the settlement statement are delivered to the borrower. At this point, the borrower has thus purchased discount points, but has received a disbursement in cash that equals the amount paid for discount points. At step 216, if the lender has applied for mortgage insurance, the lender makes payment on the single payment mortgage insurance policy and receives a certificate of insurance from the mortgage insurer. At this point, the borrower owes the sum of $102,500 at an interest rate of 6.0%. The borrower has obtained the loan with a loan to value ratio of greater than 80%, and if the lender chooses to obtain mortgage insurance, if any, the cost of such insurance is paid by the lender, not the borrower. At optional step 218, the lender sells the mortgage loan to an investor. Because the loan interest rate is 6.0% and is equal to the prevailing rate, the loan is sold at par, that is, the price received for the loan is $102,500. At step 220, occurring if the lender has obtained mortgage insurance and the borrower does not prepay the loan, a second lender paid mortgage insurance disclosure is issued to the borrower on the date of the scheduled amortization of the loan to 78% of the original value of the property.

At the closing of the transaction, the lender owns the loan, which is an asset having a value of $102,500. The lender has collected $2500 from the borrower and has disbursed $102,500 on behalf of the borrower. If the lender has chosen to purchase mortgage insurance, the lender has purchased a prepaid mortgage insurance policy at a cost of $2500. The lender's disbursements equal the combined value of the lender's receipts and the value of the asset the lender has gained from the transaction.

Initiating the loan transaction with a note rate of 6.75% gives the loan a higher value because the note rate of 6.75% is higher than the prevailing rate of 6.0%. As noted above, if the loan had been concluded at 6.75%, the value of the loan to the lender or to a potential purchaser of the loan would have been $105,000.

In addition, issuing the loan for a higher amount than required for the purchase makes a sum of $2500 available that can be disbursed on behalf of the borrower. The lender accepts $2500 from the borrower for the purchase of discount points, but is able to disburse the sum of $102,500 on behalf of the borrower at closing, thereby structuring the transaction in such a way that the borrower receives a disbursement of $2500 that compensates him or her for the outlay required to purchase the discount points.

In adjusting the loan interest rate to 6.0%, the lender reduces the value of the loan from $105,000 to $102,500. Originally, the value of the loan was greater than the value of the disbursements to be made in consideration of the loan, and the rate reduction decreases the value of the loan so that it is equal to the disbursements to be made. After the conclusion of the transaction, the value of the loan equals the disbursements the lender has made. In addition, the lender has received $2500 from the borrower in exchange for the adjustment. The total value of the assets received by the lender is therefore $105,000. The lender is thus able to disburse the sum of $102,500, and also to spend $2500 to purchase the mortgage insurance policy, making the transaction more attractive to the borrower.

However, the interest rate on the loan is higher than it would be if the sum of $2500 had been used as an upfront payment to reduce the interest rate from the prevailing rate. If the lender had simply initiated the loan at a rate of 6.0% and allowed the borrower to purchase discount points to reduce the rate below the prevailing rate, the purchase of $2500 in discount points might have resulted in a reduction to a rate of 5.25%. However, mortgage insurance would have to be purchased for such a loan, requiring either an upfront payment or a monthly payment on the part of the borrower. Therefore, the total expenditure by the borrower can be lower for the transaction described above than for a loan transaction at the prevailing rate, reduced by a purchase of discount points, that requires borrower-paid mortgage insurance. In addition, the payment by the borrower of $2500 for the purchase of discount points at step 206 above, qualifies the borrower for a tax deduction of $2500. Such a transaction structure, therefore, may give the borrower a significant tax advantage without increasing his or her overall costs.

FIG. 3 illustrates the steps of an alternative process of structuring a mortgage loan and mortgage insurance transaction according to an aspect of the present invention. The process 300 is similar to the process 200 discussed above, but the process 300 implements the transaction in such a way that the borrower does not purchase any discount points. The process 300 implements a transaction wherein the sum required from the lender in order to finance the purchase is $100,000, the prevailing interest rate is 6.0% and a single payment policy providing mortgage insurance is available for $2500. The mortgage insurance policy may suitably be a package including a job loss feature, with the package being priced and marketed according to the teachings of U.S. patent application Ser. No. ______ noted above. At step 302, upon a customer's application for a mortgage in the amount of $100,000 at an interest rate of 6.0% for a home purchase, with the purchase price being $111,111, the customer is offered a loan of $102,500 at an interest rate of 6.75%, the 6.75% being 75 basis points above the prevailing rate of 6.0%. Because the loan amount is $2500 more than is needed for the purchase, and because the loan interest rate is higher than the prevailing rate, the loan has a value of $105,000, taking into account repayment risk. Thus, at step 304, upon a borrower choice not to purchase discount points to reduce the interest rate, the loan rate is maintained at 6.75%. When the borrower locks the interest rate, the rate is set to the rate of 6.75%. At step 306, the annual percentage rate (APR) for the loan is computed for disclosure documents. At step 308, the lender optionally submits an application for a lender paid single premium mortgage policy to a selected mortgage insurer. The policy applied for may suitably be a package including a job loss feature. At step 310, the lender prepares a settlement package for the loan. If the lender has applied for mortgage insurance for the loan, this step occurs after the lender has received a commitment to insure. The settlement package includes a note and mortgage with a rate of 6.75%, a check or other means of payment for $100,000, to be disbursed according to the borrower's financing needs and a check or other means of payment for $2500, to be disbursed directly to the borrower. If the lender has applied for mortgage insurance, the package includes a lender paid mortgage insurance disclosure statement. The package also includes a standard settlement statement, showing the sums received from or on behalf of the borrower and the disbursements of those sums. At step 312, the sum of $102,500 is disbursed on the borrower's behalf. $100,000 is disbursed as required to meet the borrower's financing needs and $2,500 is disbursed directly to the borrower. In addition, the lender paid mortgage insurance disclosure and the settlement statement are delivered to the borrower. At step 314, if the lender has applied for mortgage insurance, the lender makes payment on the single payment mortgage insurance policy and receives a certificate of insurance from the mortgage insurer. At this point, the borrower owes the sum of $102,500 at an interest rate of 6.75% and has received a loan with a loan to value ratio of more than 80%. If the loan includes mortgage insurance, no additional payment from the borrower is required for the insurance. At optional step 316, the lender sells the mortgage loan to an investor. Because the loan interest rate is 6.75% and is above the prevailing rate, the loan is sold at a premium, that is, the price received for the loan is greater than $102,500.

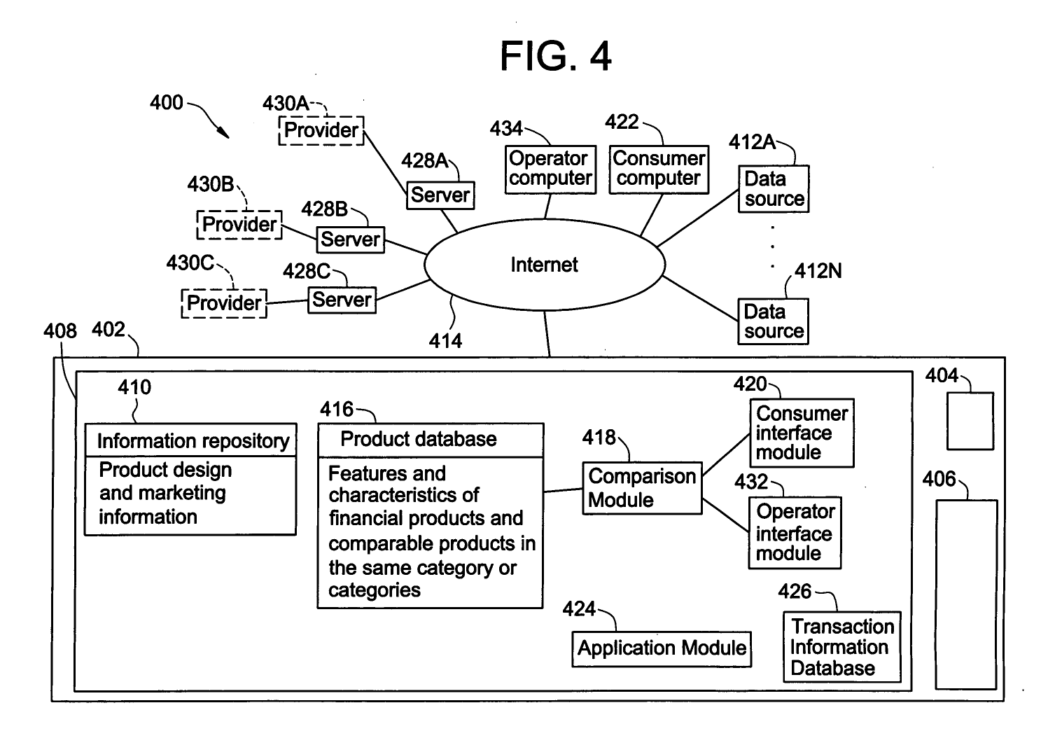

At step 318, occurring of the lender has obtained mortgage insurance and the borrower does not prepay the loan, the process proceeds to step 318 and a second lender paid mortgage insurance disclosure is issued to the borrower on the date of the scheduled amortization of the loan to 78% of the original value of the property. FIG. 4 illustrates a financial product design and marketing system 400 according to an aspect of the present invention. The system 400 suitably includes a server 402, preferably comprising a processor 404, memory 406 and long term storage 408. The long term storage 408 suitably hosts a product design information repository 410. The repository 410 suitably includes information to be used in designing and marketing products. The information may suitably include descriptions of consumer preferences, legal regulations controlling the characteristics of financial products to be offered in particular jurisdictions and financial considerations to be taken into account when designing products. For example, in the case of a mortgage insurance policy, financial considerations may include a requirement that the insurance provide suitable protection to investors and that it be offered at a cost that is competitive with other such products. Information to be stored in the repository 410 is suitably taken from multiple data sources such as the sources 412A . . . 412N. The sources 412A . . . 412N may suitably include manual data entry stations, subscription data updates and the like, and may be accessible by the server 402 through a publicly available network such as the Internet 414, or through any other suitable communication technique.

The system 400 also includes a product database 416, suitably implemented as a stored file hosted in the long term storage 408. The product database 416 includes details of a number of financial products to be offered, as well as details of other products of the same type that may be presented for comparison. The products may suitably include various forms of mortgage insurance, adopting different implementation and pricing strategies, as well as other associated features. Products in the database may include packages including a combination of job loss insurance and mortgage insurance, with such packages being designed employing the teachings of U.S. Ser. No. ______ noted above. One of the financial products having details stored in the database 416 may suitably be a mortgage financing transaction implemented through a process similar to those described above in connection with FIGS. 1-3. That is, a loan is offered to a borrower for an amount including a base amount and an excess amount. In addition, the loan carries a nominal interest rate greater than the prevailing rate. Depending on borrower preferences, the interest rate for the loan is brought down to the nominal interest rate through the purchase of discount points by the borrower. Alternatively, the loan remains at a rate higher than the nominal rate. At the conclusion of the transaction, the base amount is disbursed to meet the financing needs of the borrower and the excess amount is disbursed to the borrower in cash. A prepaid mortgage insurance policy may be purchased to insure the loan.

Different implementation and pricing strategies for each product may produce different results for different consumers. In the case of a mortgage insurance policy, different methods of implementation may affect a borrower's closing costs or monthly payments. Some implementations of mortgage financing may produce various forms of tax advantages, and these tax advantages may be different for different consumers, depending on the particular financial situation of the consumer. Therefore, the system 400 also includes a comparison module 418, suitably implemented as a software program stored in the long term storage 408 and executed under the control of the processor 402. The comparison module receives information related to a contemplated transaction and compares various products for which information is stored in the database 416, in light of the information provided to describe the transaction. The comparison module 418 may suitably receive information passed from a consumer interface module 428, suitably implemented as software. A consumer may, for example, enter information related to a mortgage transaction. Such information may include the contemplated price of the property, the desired down payment and the contemplated interest rate. In addition, the consumer may, if desired, also enter additional information related to his or her tax status, such as filing status, income and expected deductions other than those related to mortgage loan under consideration. The comparison module 418 then examines the database 416, identifies the financial products that can be used in connection with the desired transactions, makes computations about the effects of each product and presents this information to the consumer. The information presented to the consumer may suitably include descriptions of closing costs, monthly payments, interest, principal and mortgage insurance components of each payment. The information may also include annual tax deduction information, particularly for the first year, that is, the period beginning with the closing of the mortgage loan until the end of the year in which that event occurs. Tax deduction information for the first year of a loan is particularly useful to consumers because it shows them the immediate tax consequences of transactions. In addition, the first year of a loan often includes tax deductible closing costs that do not recur in subsequent years.

Suitably, the consumer interface module 420 presents hypertext forms and displays in order to receive information from and present information to the consumer. Information received from the consumer is extracted from the forms and passed to the comparison module 418, and information from the comparison module 418 is suitably presented using a suitably formatted hypertext display. The consumer interface module 420 may suitably transfer information to and from a hypertext browser hosted on a consumer computer such as the consumer computer 422, with the consumer computer 422 communicating with the server 402 through the Internet 414.

The product database 416 suitably includes details of several different products, each of which can be evaluated by the comparison module 418 in light of a specific set of requirements. Different products that may be available include conventional mortgage insurance in which payments are made monthly along with the mortgage payment, single payment mortgage insurance in which mortgage insurance is provided for the duration of a loan in exchange for a single initial payment, and financing transactions in which a lender allows a borrower to obtain a loan for an amount greater than 80% of the value of the property, with the transaction being structured so as to enhance the value of the loan to the lender so that the lender can issue the loan to the borrower without requiring the borrower to make payments for mortgage insurance. Adjustments are made to parameters of the loan, for example increasing the interest rate, in order to enhance the value of the loan. In particular, as noted above, one or more products implemented according to the processes 100, 200 and 300 of FIGS. 1, 2 and 3, respectively, are included.

The comparison module 418 receives transaction information from the consumer interface module, examines the various products that are available and performs a preliminary analysis, choosing products that can be used with the transaction that is described. The comparison module 418 then evaluates each product using the information that has been provided and obtains results. The results may include, for example, the monthly payment including principal and interest, the monthly mortgage insurance premium, the total monthly payment including the mortgage insurance premium, the total amount borrowed, the total amount repaid, the initial amounts paid or received at closing and the tax consequences of using each product. The results are suitably presented to the consumer interface module 420, which presents the results to the consumer. The results are suitably presented in the form of a hypertext display for presentation by a browser hosted on the consumer computer 422.

The server 402 may also suitably host an application module 424, accessible by the consumer interface module. The application module 416 allows a user to select a desired product, suitably after comparison of available products using the comparison module 418. The consumer interface module 420 may suitably present a form allowing the user to enter appropriate information and selections and pass the information to the application module 424. The application module 424 extracts the information and selections and retrieves information related to a selected product from the database 408. The application module 424 requests additional information from the consumer as required. Requests for additional information, and information submitted in response to such requests, are transferred using the consumer interface module 420.

The application module 424 performs any processing that may be necessary to adapt the information entered by the consumer to the selected product information and to prepare information for presentation to the consumer. An example of processing that may be necessary includes computing monthly payment amounts, finance charges, down payments and closing costs and the like. Once the required information has been collected and processed, a summary of the submitted consumer information and the details of the transaction being applied for are presented to the consumer. Once the consumer accepts the details of the transaction, the submitted consumer information and transaction details are transferred for appropriate action. For example, a transaction record may be created or updated in a transaction information database 426. A transaction record stored in the database 426 preferably includes submitted consumer information, transaction details, identification of the various providers performing the transaction, such as lenders and mortgage insurance companies, and any other required details. In addition to creating or updating the transaction record 426, the application module 424 suitably provides appropriate transaction information to any providers engaged in the transaction. This end may suitably be accomplished by transferring appropriate data to servers such as the servers 428A-428C, maintained by the providers 430A-430C.

The server 402 may also host an operator interface module 432, for communicating with an operator computer such as the computer 434. The operator interface module 432 suitably allows access to the elements of the server 402 and provides a user with more freedom than is allowed to a user obtaining access through the consumer interface module 420. Typically, the consumer interface module 420 allows a consumer access only to the comparison module 418, and the application module 424 allows a user to obtain information about various products that may be available and to enter into a transaction for a selected product. The operator interface module 432 allows a user considerably greater freedom, with the degree of freedom being determined by the classification into which the operator falls. Operators may include employees of lenders, mortgage insurers and the like, in which case the operator interface module 432 would suitably allow such users access to selected areas of the product database 416 in order to enter or update information relating to products offered by their employers. Other classes of operators may include persons responsible for maintaining and updating the system 400. Such persons would suitably have wide ranging access to all features of the system 400, with the operator interface module 432 serving as a tool to direct the operator to the various modules and data repositories. Suitable security and authentication procedures are preferably used to protect data and identify users, and to identify a user as being in a particular class and therefore entitled to a particular level of access.

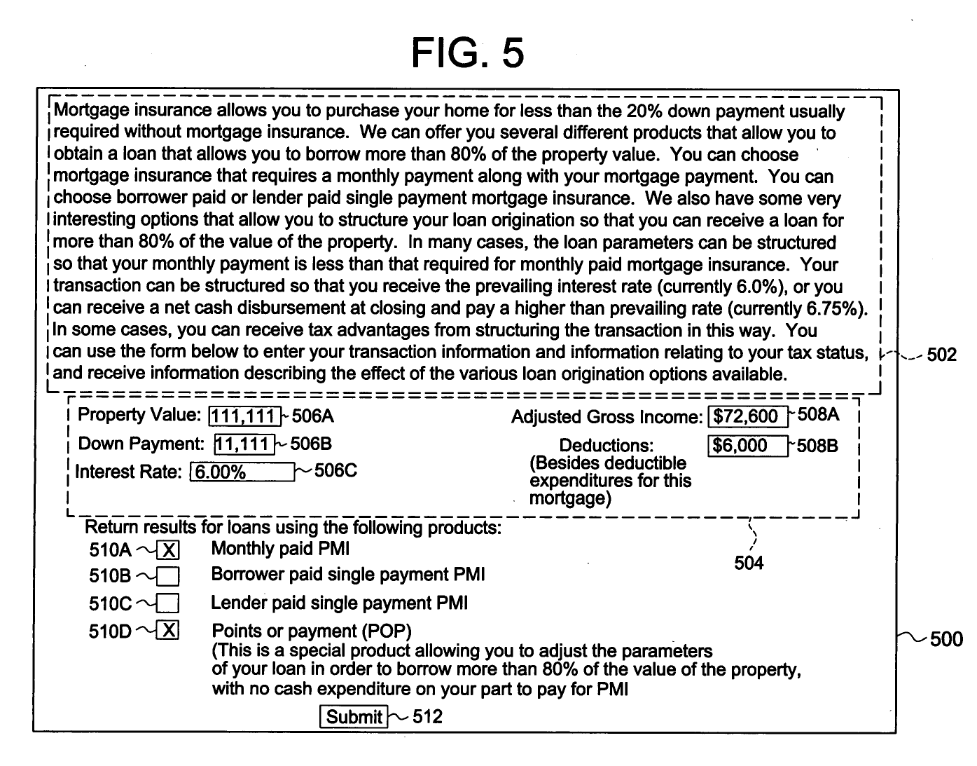

FIG. 5 illustrates a form 500, suitably presented to a consumer in order to provide comparison information relating to various financial products. The form 500 may be presented by, for example, the consumer interface module 420 of FIG. 4. The form 500 includes a promotional information area 502, including general information about various ways of structuring mortgage insurance. The promotional information area 502 includes generalized information about the costs and benefits of each of a number of products. The form 500 further includes a transaction information entry area 504, allowing the user to enter information related to a contemplated transaction. The information entry area 504 includes fields 506A-506C, for property value, down payment and interest rate, respectively. The information entry area 504 further includes fields 508A and 508B, for the user's adjusted gross income and deductions other than those related to the contemplated mortgage. Entering the information in the fields 508A and 508B is optional for the user, but entering this information allows a more accurate estimate of the tax effects of the various available products to be calculated. The form 500 also includes checkboxes 510A-510E, to allow the user to select of products for which results are to be returned, and a “submit” button 512, for entering the data for comparison.

For example, a consumer may be contemplating a transaction involving the securing of a $100,000 loan for the purchase of a home costing $111,111. The consumer has entered the property value and down payment in the fields 506A and 506B. An interest rate of 6.0% appears in the field 506C, this may suitably have been entered by the consumer or may have been taken from a source showing currently prevailing interest rates, such as may be provided by a financing company, real estate agency or other party interested in providing home purchase information to consumers. The fields 508A and 508B show income of $72,600 and deductions of $6000, respectively. This information is useful in determining the tax consequences of the selection of various products.

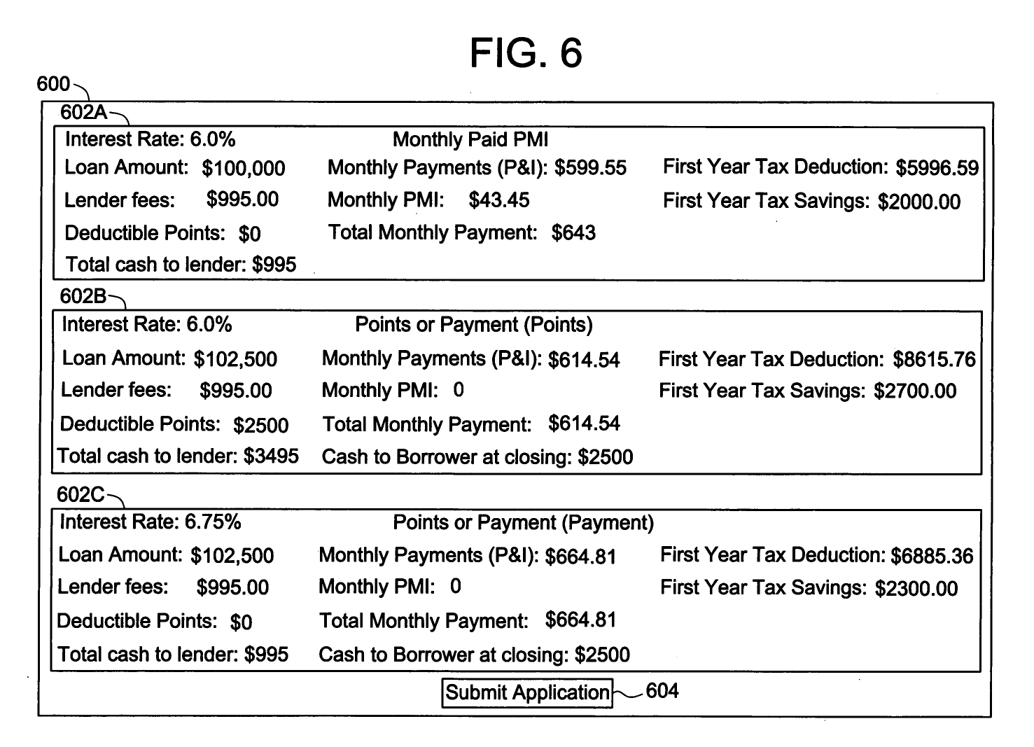

FIG. 6 illustrates a comparison display 600, produced after submission of transaction information using the form 500 of FIG. 5. The display 600 presents information provided by the comparison module 418 of FIG. 4. The display 600 includes result presentation areas 602A-602C. Each of the result presentation areas 602A-602C presents details of a mortgage loan transacted using an available product. The details include closing costs, monthly principal and interest, monthly mortgage insurance premium, total monthly payment including principal and interest, annual tax deduction for the first year of the loan and total tax savings after the first year of the loan.

In the example illustrated here, the presentation area 602A provides information for a loan with traditional private mortgage insurance, with monthly payments by the borrower. The loan amount is $100,000 and lender fees are $995. The monthly payment for principal and interest for the loan is $599.55 and the amount to be paid each month for mortgage insurance is $43.45, so that the total monthly payment is $643. The tax deduction attributable to the first year of the loan is due to tax deductible interest of $5996.59, resulting in a tax saving for the borrower of $2000.

The presentation area 602B provides information for a loan transaction similar to that described above in connection with the discussion of FIG. 2. This example assumes that the borrower has elected to purchase discount points to bring the loan interest rate to the prevailing rate of 6.0%. The loan amount is $102,500, lender fees are $995 and discount points are to be purchased at a cost of $2500, requiring a payment by the borrower of $3495. At the closing of the transaction, $2500 will be disbursed to the borrower in cash. The monthly payment for principal and interest for the loan is $614.54 and no monthly payment is to be made for mortgage insurance. The tax deduction attributable to the first year of the loan is due to tax deductible interest of $8615.76, resulting in a tax saving for the borrower of $2700.

The presentation area 602C provides information for a loan transaction similar to that described above in connection with the discussion of FIG. 3. This example assumes that the borrower has not elected to purchase discount points, so that the loan interest rate is maintained at the rate of 6.75%. The loan amount is $102,500, lender fees are $995 and no discount points are to be purchased. At the closing of the transaction, $2500 will be disbursed to the borrower in cash. The monthly payment for principal and interest for the loan is $664.81 and no monthly payment is to be made for mortgage insurance. The tax deduction attributable to the first year of the loan is due to tax deductible interest of $6885.36, resulting in a tax saving for the borrower of $2300.

The form 600 further includes “graphic display” button 604. The “graphic display” button directs the consumer interface module 420 to construct a graphic display, showing comparative information in an easily viewable form, suitably in the form of graphs or charts. The form 600 further includes a “submit application” button 606. Activation of the “submit application” button 604 invokes the application module 416, allowing the user to select desired products and providers and submit information in order to begin a loan application using the selected products and providers.

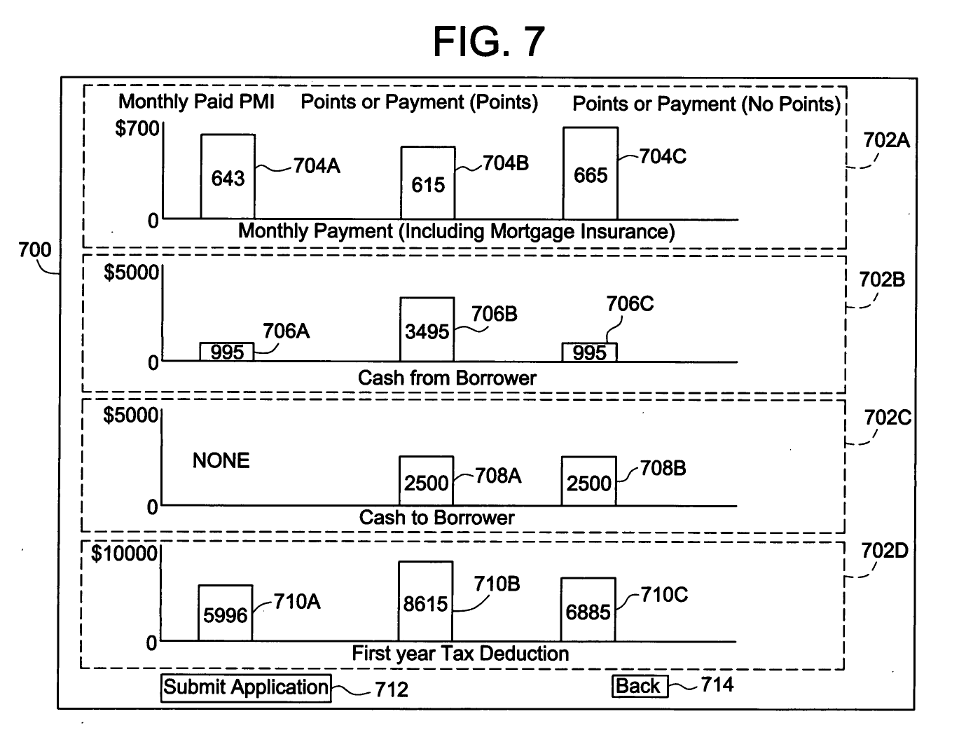

FIG. 7 illustrates a form 700, presented after activation of the “graphic display” button 604 of FIG. 6. The form 700 presents graphics showing selected information presented in numerical format in the form 600. The form 700 includes bar graphs 702A-702D. The bar graph 702A includes the bars 704A-704C. The bar 704A graphically illustrates the monthly payment for a mortgage using monthly paid mortgage insurance. The bar 704B illustrates the monthly payment for a mortgage using lender paid mortgage insurance with the purchase of discount points, similar to that transacted using the process 200 of FIG. 2. The bar 704C illustrates the monthly payment for a mortgage using lender paid mortgage insurance without the purchase of discount points, similar that transacted using the process 300 of FIG. 3.

The bar graph 702B includes the bars 706A-706C, showing the borrower payments required for each of the products. The bar graph 702C includes the bars 708A and 708B, showing the disbursements to the borrower resulting from the use of each of the lender paid mortgage insurance products. The monthly paid mortgage insurance product does not involve a disbursement to the borrower, so the bar graph 702C does not show a bar associated with that product. The bar graph 702D includes the bars 710A-710C, showing the first year tax deductible expenditures resulting from the use of each of the products.

The form 700 also includes a “submit application” button 712, and a “back” button 714. Activation of the “submit application” button 712 invokes the application module 416, and activation of the “back” button returns the user to the form 600 of FIG. 6.

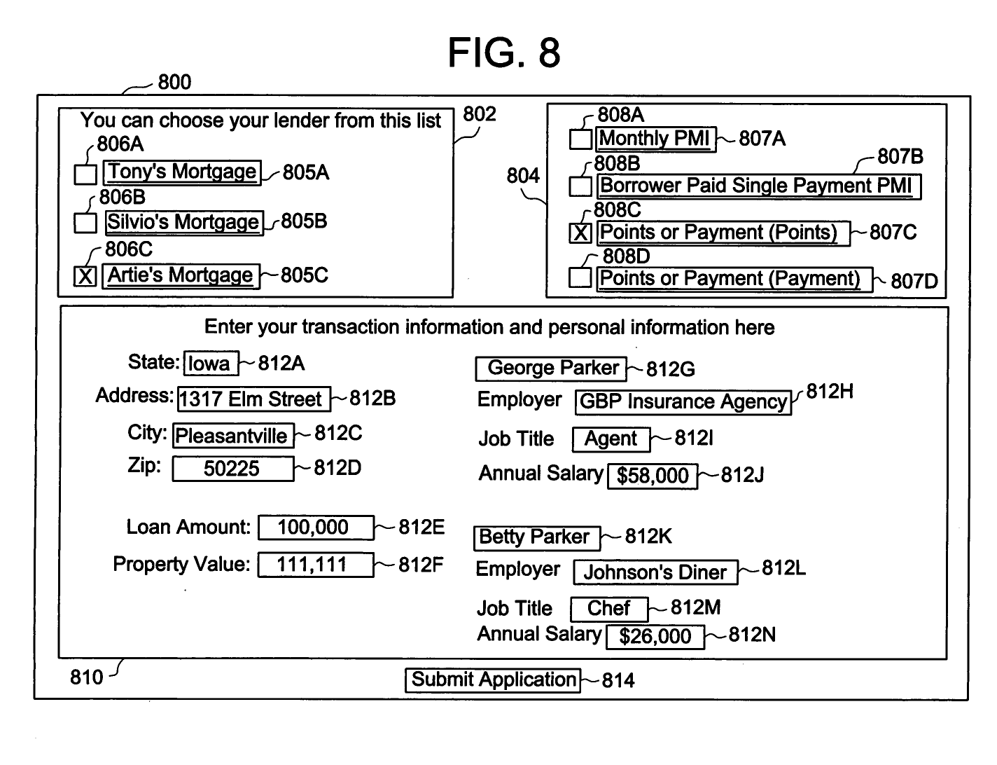

FIG. 8 illustrates a form 800, allowing a user to make initial selections of products and providers and to enter personal and transaction information for submission. The form is preferably presented by the operator interface module 420, based on information received from the application module 418. The form 800 includes a lender selection area 802 and a product selection area 704. The lender selection area 802 includes brief lender identifiers 805A-705C, along with checkboxes 806A-706C, to allow a user to select a lender for the application. The product selection area 804 includes brief product descriptions 807A-807D, along with checkboxes 808A-808D, to allow a user to select a product for the transaction. The product descriptions are preferably of various mortgage insurance options. The lender identifiers 805A-805D and product descriptions 807A-807D are preferably in the form of hyperlinks to allow the user to obtain additional information by activating a hyperlink in order to retrieve a hypertext page including additional information.

The form 800 further includes a borrower and transaction information area 810, including fields 812A-812N for borrower and transaction information. The form 800 further includes a “submit” button 814, to allow submission of the information and selections by the user. Once the user activates the “submit” button 814, the consumer interface module 412 passes the submitted information to the application module 416. The application module 416 retrieves information for the selected lender and product and performs processing in order to compute transaction details, for the transaction.

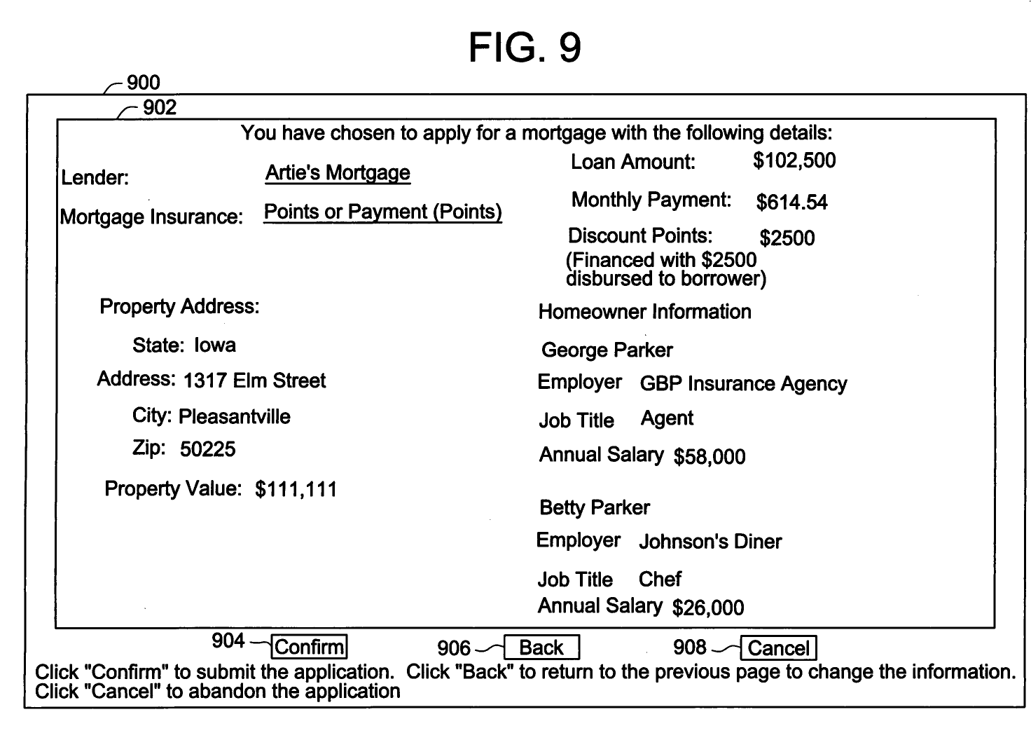

FIG. 9 illustrates a form 900, presenting transaction details for a contemplated transaction described by information and selections submitted using the form 800 of FIG. 8. The form 900 includes a transaction summary 902, listing relevant details of the transaction as computed by the application module 424. The form 800 also includes a “submit” button 904, and a “back” button 906, allowing the user to choose to submit a transaction application or to return to the form 700 to make changes in order to submit new information. The form 900 also includes a “cancel” button 908, in order to allow the user to abandon the application. If the user activates the “submit” button, the transaction information is suitably stored in the transaction information database 426 and an application process is initiated, with information being forwarded to responsible providers for action.

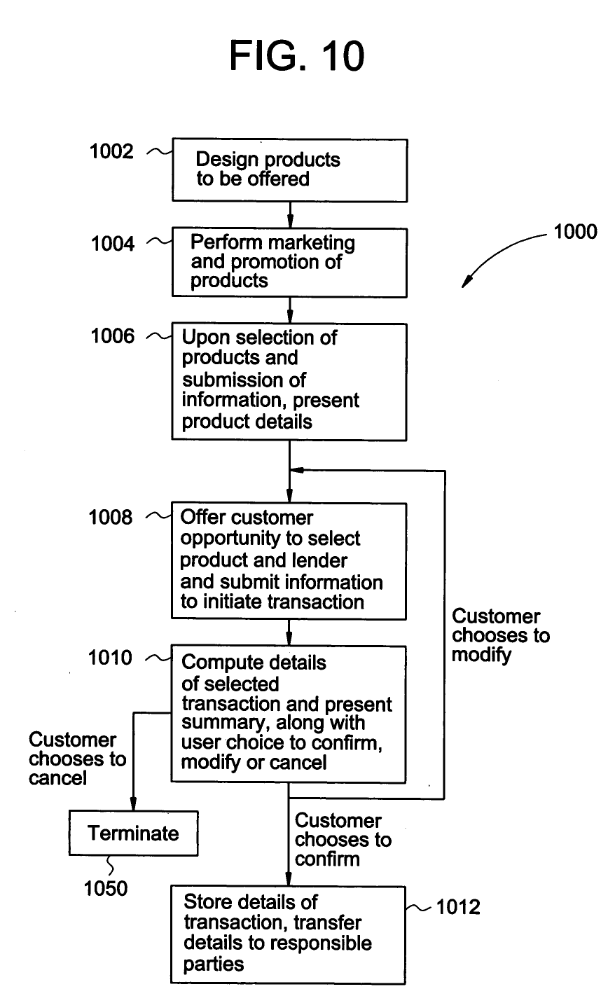

FIG. 10 illustrates a process 1000 of marketing and implementing mortgage financing transactions according to an aspect of the present invention. The process 1000 is suitably performed using a system such as the system 400 of FIG. 4. At step 1002, a variety of products are designed to be offered in implementing a mortgage transaction. One or more of the products includes a mortgage financing transaction implemented using a process similar to the processes of FIGS. 1, 2 and 3. A loan is issued including a base amount sufficient to meet the borrower's financing needs. The loan also has an interest rate higher than the nominal rate. The borrower is given the opportunity to purchase discount points to reduce the loan interest rate to the prevailing rate. If the borrower purchases discount points, the rate is reduced to the prevailing rate. Otherwise, the loan interest rate is maintained at the higher rate. At the close of the transaction, loan proceeds are disbursed on behalf of the borrower. The base amount of the loan is disbursed as needed to meet the borrower's financing needs and the excess amount of the loan is disbursed in cash to the borrower. In addition, a prepaid mortgage insurance policy may be purchased to insure the loan.

At step 1004, marketing and promotion of various available products is performed, suitably in a context of providing educational and promotional material relating to mortgage insurance. The marketing and promotion may suitably give the customer an opportunity to select products for comparison, provide transaction details relating to a contemplated transaction, and provide personal financial information that can be used to determine the tax consequences of various financial choices. At step 906, upon submission by a customer of transaction information and financial information, and selection of products for comparison, details of each selected product are presented. Such details may include monthly payment, tax deduction and tax saving information. At step 908, a customer is offered an opportunity to select a product and lender and submit an application for a mortgage using the selected product and lender. At step 1010, upon submission by a customer of required information and a selection to submit an application, a summary of the details of the transaction is presented to the customer and the customer is requested to confirm, modify or cancel the transaction. If the customer chooses to modify the transaction, the process returns to step 908. If the customer chooses to cancel the transaction, the process terminates at step 1050. If the customer chooses to confirm the transaction, the process proceeds to step 1012 and the details of the transaction are stored and transferred to responsible parties for accomplishing the transaction.

While the present invention is disclosed in the context of aspects of an embodiment employing a specific system and exemplary web pages, it will be recognized that a wide variety of implementations may be employed by persons of ordinary skill in the art consistent with the above discussion and the claims which follow below.

1. A method for implementing a mortgage financing transaction, comprising the steps of:
preparing a loan in an amount including a base amount and an excess amount, the base amount being the amount necessary for financing and the excess amount being sufficient to purchase a prepaid mortgage insurance policy, the loan interest rate being initially set to an amount above the prevailing rate;
offering a borrower a choice to purchase discount points to reduce the interest rate to the prevailing rate;
if the borrower chooses to adjust the loan interest rate to the prevailing rate, receiving a sum from the borrower sufficient to purchase discount points required for the adjustment and setting the loan interest rate to the prevailing rate, and if the borrower chooses not to adjust the loan interest rate to the prevailing rate, maintaining the loan interest rate at the amount above the prevailing rate; and
disbursing the base amount and the excess amount of the loan on behalf of the borrower, the base amount of the loan being disbursed to achieve the financing needs of the borrower, the excess amount being disbursed directly to the borrower.

2. The method of claim 2, further comprising an optional step of purchasing a prepaid lender paid mortgage insurance policy to insure the loan.

3. The method of claim 2, wherein the mortgage insurance policy includes a job loss component making a specified maximum number of payments during a period of involuntary unemployment of a borrower.

4. The method of claim 3, wherein the loan interest rate is set such that the value of discount points required to adjust the loan to the prevailing rate is equal to the excess amount of the loan.

5. The method of claim 4, wherein the loan interest rate is set such that the value of discount points required to adjust the loan to the prevailing rate is approximately equal to the cost of a prepaid lender paid mortgage insurance policy.

6. A system for marketing and implementing financial products, comprising:
a data repository storing information used to design products;
a product database including information relating to a variety of financial products, at least one of the products for which information is stored in the database including a technique for mortgage financing including adjusting the amount of the loan to include an excess amount in excess of a borrower's financing needs, adjusting the interest rate of the loan to an amount above the prevailing rate so as to provide for an increased value of the loan, and optionally including a prepaid mortgage insurance policy with the loan, further allowing the borrower the option of purchasing discount points to reduce the interest rate to the prevailing rate, the technique further including disbursing the excess amount of the loan to the borrower in cash at the closing of the loan; and
a comparison module operative to receive information relating to a contemplated transaction, the comparison module being further operative to compute the financial effects of various available products.

7. The system of claim 6, further comprising a consumer interface module for receiving the information relating to a contemplated transaction in the form of inputs from a consumer and transfers the information to the comparison module, the consumer interface module being operative to receive information relating to the financial effects of various products from the comparison module and present the information to the consumer for review.

8. The system of claim 7, wherein the consumer interface module receives information related to a contemplated transaction by presenting the consumer with a set of hypertext forms allowing the consumer to provide the information and presents information to the consumer in the form of hypertext displays.

9. The system of claim 8, wherein the prepaid mortgage insurance policy that may be purchased by the lender includes a job loss protection feature making up to a specified maximum number of mortgage payments during a period of involuntary unemployment of a borrower.

10. The system of claim 9, wherein the comparison module is operative to receive information relating to the borrower's tax status and to compute and display information showing the tax consequences of various products.

11. The system of claim 10, further including an application module allowing a borrower to select products and providers and to submit information required to initiate a transaction, the application module being operative to process the provided information and to present the process information to responsible parties in order to initiate the transaction.

12. The system of claim 11, wherein the data repository, product database, comparison module, application module and consumer interface module are implemented as software hosted on a computer.

13. The system of claim 12, wherein the application module presents information to responsible parties by transferring the information to external computers operated by or for the responsible parties.

14. A method of marketing and implementing mortgage financing transactions including mortgage insurance, comprising the steps of:
providing educational and general promotional information relating to various financing options, at least one of the financing options including implementing a mortgage financing transaction in such a way that the amount of the loan includes an amount in excess of a borrower's financing needs, the interest rate of the loan is set at a higher rate than the prevailing rate in order to provide for an increased market value of the loan, and the lender may optionally purchase a prepaid mortgage insurance policy to insure the loan, with the borrower being given the option of purchasing discount points to reduce the interest rate to the prevailing rate, with a disbursement of the excess amount of the loan being made to the borrower in cash at the closing of the loan transaction;
receiving information relating to a contemplated transaction and to the financial condition of a borrower; and
computing and presenting information relating to the effects of various available products.

15. The method of claim 14, wherein the prepaid mortgage insurance policy includes a job loss protection feature making up to a specified maximum number of mortgage payments during a period of involuntary unemployment of a borrower.

16. The method of claim 15, wherein the step of computing and presenting information relating to the effects of various available products includes presenting information relating to the tax consequences of the various products.

17. The method of claim 16, further including a step of receiving selections of desired products and providers from a borrower, as well as information related to the transaction and to the borrower, as required to initiate a transaction, processing the information received from the borrower and presenting the information to responsible parties in order to initiate the transaction.

18. A software program running on a computer, operative to:
provide educational and general promotional information relating to various financing options, at least one of the financing options including implementing a mortgage financing transaction in such a way that the amount of the loan includes an excess amount in excess of a borrower's financing needs, the interest rate of the loan is at a higher rate than the prevailing rate in order to provide for an increased value of the loan, and a prepaid mortgage insurance policy is included with the loan, with the borrower being allowed the option of purchasing discount points to reduce the interest rate to the prevailing rate, with a disbursement of the excess amount of the loan being made to the borrower in cash at the closing of the loan transaction;
receive information relating to a contemplated transaction and to the financial condition of a borrower; and
compute and present information relating to the effects of various available products.
